(19) United States
(12) Patent Application Publication
(10) Pub. No.: US 2026/0065539 A1
(43) Pub. Date: Mar. 5, 2026

(54) INTELLIGENT MAP-MAKING SYSTEM AND DEVICE FOR WE-MAP

(71) Applicant: LANZHOU JIAOTONG UNIVERSITY, Lanzhou (CN)

(72) Inventors: Haowen YAN, Lanzhou (CN); Xiaolong WANG, Lanzhou (CN); Zhuo WANG, Lanzhou (CN); Jingzhong LI, Lanzhou (CN); Weifang YANG, Lanzhou (CN); Wenjun MA, Lanzhou (CN); Renzhong GUO, Lanzhou (CN); Qili YANG, Lanzhou (CN); Ben MA, Lanzhou (CN); Shen YING, Lanzhou (CN)

(21) Appl. No.: 19/026,437

(22) Filed: Jan. 17, 2025

(30) Foreign Application Priority Data
Aug. 29, 2024 (CN) 202411198689.3

(51) Int. Cl. G06T 11/20; G06F 3/01

(52) U.S. Cl. CPC G06T 11/26; G06F 3/011

(57) ABSTRACT

Disclosed are an intelligent map-making system and device for a We-map, which mainly include an intelligent map-making system for a We-map and an intelligent making device on a mobile terminal. The system includes: a We-map natural interaction making module based on gesture interaction, voice interaction and eye movement interaction, a multi-modal interaction data fusion device, a user portrait building module, a We-map self-adaptive designer and a We-map intelligent generator. The device includes a We-map natural interaction interface designer, a We-map mapping interface optimizer, a We-map data processor, a We-map memory and a We-map user manager.

### TECHNICAL FIELD

The disclosure relates the technical field of cartography and geographic information engineering in the surveying and mapping science and technology, and in particular to an intelligent map-making system and device for a We-map.

### BACKGROUND

A We-map is a new type of map, ordinary people can participate in the process of the cartography in the era of we-media. The map has the main characteristics of micro-content, a low threshold, a fast making speed and personalization.

Micro-content: Different from content of common topographic maps and thematic maps, the content expressed on the We-map can be less but concise as long as the content can satisfy users' needs of specific situations.

Low threshold: We-map makers are not required to have professional cartographic knowledge or cartography-related knowledge, nor participate in long-term and specialized mapping skill training.

Fast making speed: Making of the We-map does not need to be subjected to complicated processes such as projection selection, symbol design, data processing, map drawing, and map decoration that are required for making of conventional maps, and the making of the We-map should be completed in relatively short time.

Personalization: In most cases, a We-map has only a small number of users, therefore, the We-map should emphasize feelings, preferences and special needs of the users who the We-map directly serves in terms of content selection, expression mode, communication application, etc.

At present, making of the We-map mainly relies on a traditional tool mapping method (including physical tools such as brushes, carving knives and modern mice that have been used since ancient times, as well as electronic pens, virtual pen and ink tools used in today's electronic age). Tool mapping not only requires cartographers to have professional cartographic knowledge, but also requires special map-making skill training, and map making includes map projection selection, map layout design, map symbol design, cartographic data analysis and processing, map element drawing, map decoration and other making processes, resulting in a slow mapping speed and a long making cycle. Obviously, the high requirements and the long cycle of the tool mapping methods cannot be adapted to the characteristics of a low threshold and a fast making speed of making for the We-map.

A flow-based standardized map making method is disclosed in the China patent specification with No. CN202311502422.4. In the method, a target template map is selected from a backend template map database by determining a type of a target map, then, a map layer and a target layer corresponding to the target map are created according to the type of the target map, and elements and fields required on the target layer are selected from a backend layer element and field related database for corresponding realistic scenes. Finally, the selected data including the layer elements and fields are correspondingly stored in a backend layer database and a backend map database. Although the technology provides a process-based and standardized online map making method, the method still belongs to the category of “tool mapping”, which requires physical tools such as mice and keyboards. From this point of view, the threshold of map making has not been lowered, the making cycle has not become shorter, and it is difficult to satisfy the needs of personalization and micro-content. Moreover, map making devices are concentrated on a network terminal and a computer desktop terminal, and there are still technical gaps in map making devices on a mobile terminal.

A map creating device and a map making system are disclosed in the international invention patent with No. PCT/JP2021/044852, which aims at achieving the purpose of creating an accurate route map even when an error occurs in a recognized position, avoiding creating a route map by recognizing different nodes as the same node, and avoiding from creating a route map different from reality. However, making and generation are only aimed at the path map generated in a mobile robot movement process, and the nodes captured in the movement process are updated to the path map, with map information collection as the technical focus. There is no significant improvement in map making technology, which cannot satisfy the personalized and micro-content requirements required by the map making technology.

### SUMMARY

The technical problem to be solved by the disclosure is to provide an intelligent map-making system and device for a We-map, which overcomes the defects of a high threshold for cartographers, a low making speed, failure of map content expression to satisfy user demands and neglect of map making demands and experience of users during making of the map.

To solve the above technical problem, the disclosure provides an intelligent map-making system and device for a We-map, which solves the intelligent making problem of the We-map based on a mobile terminal under a we-media environment, overcomes the defects of a long making cycle and a slow mapping speed of an existing map making technology, and fills the technical gap of the lack of a map making device on a mobile terminal, so as to boost the development of cartography, provide the society with a faster and intelligent map making technology, provide users with more convenient geographic information services, and improve the quality of life of the people, thereby satisfying the major strategic needs of the country and providing geographic information data.

To achieve the above objective, the disclosure employs the following technical solutions:

An intelligent map-making system and device for a We-map, including an intelligent map-making system for a We-map and an intelligent map-making device on a mobile terminal.

Optionally, the intelligent map-making system for a We-map includes: a We-map natural interaction making module, a multi-modal interaction data fusion device, a user portrait building module, a We-map self-adaptive designer and a We-map intelligent generator.

The We-map natural interaction making module obtains multi-modal interaction data for making the We-map through gesture interaction, voice interaction and eye movement interaction.

The multi-modal interaction data fusion device fuses the multi-modal interaction data into a unified coordinate sequence, fuses multi-modal interaction data of different time into the same semantic space, and dynamically calculates weights of the multi-modal interaction data.

The user portrait building module divides users into different portrait groups by acquiring behavior data and behavior characteristics of the users.

The We-map self-adaptive designer can ensure content of the We-map matches We-map content in which the users are interested.

The We-map intelligent generator evaluates the quality of the We-map by designing and optimizing an intelligent map-making process for the We-map, and realizes personalized intelligent recommendation of the We-map.

Optionally, the We-map natural interaction making module specifically includes construction of We-map making gestures, interpretation of voice interaction, and eye movement interaction and tracking.

The construction of We-map making gestures specifically includes extracting gesture characteristics of We-map making, capturing gesture information and trajectories of We-map making, and constructing an air gesture library and a touch screen gesture library to obtain input information of gesture interaction.

The interpretation of voice interaction specifically includes decoding input voice information through acoustic analysis modeling to obtain semantic information for mapping and complete interpretation of the voice interaction.

The eye movement interaction and tracking specifically includes positioning pupil positions to obtain coordinate data of eye gaze points, and obtaining input information of eye movement interaction by tracking eye movement gaze point trajectories.

Optionally, for the multi-modal interaction data fusion device, when the dynamic weights of the multi-modal interaction data are calculated, aiming at the problem of unclear reference to position of input information in the voice interaction process, the specific position is determined through gesture information, and the dynamic weights of the multi-modal interaction data are calculated according to dynamic changes of the gesture information.

Optionally, the user portrait building module specifically includes building of a mapping behavior model, marking of user mapping preferences and perception of user mapping intentions.

The building of a mapping behavior model specifically includes mining input information behavior and mapping operation characteristics of the users in the process of We-map making, thereby establishing the mapping behavior model.

The marking of user mapping preferences specifically includes marking interaction modes of the users in combination with the mapping behavior and the behavior model with operation characteristics of the users, and recording tendencies of the users to select map elements.

The perception of user mapping intentions specifically include constructing rules for inferring mapping intentions of the users on the basis of contextual information of We-map making, thereby perceiving and predicting mapping purposes of the users.

Optionally, the We-map self-adaptive designer specifically includes self-adaptive interaction design under user perceptions, self-adaptive expression of We-map content, design of We-map templates and selection of the We-map content.

Optionally, for the We-map intelligent generator,
the We-map making process design and optimization refers to aiming at the characteristics of a low threshold, micro-content, a fast making speed and personalization of the We-map, establishing a common making process for the We-map, and optimizing the making process for the We-map according to user preferences.

The We-map evaluation further includes constructing a We-map evaluation model by taking evaluation factors including data quality, map functionality, aesthetics, explicability, reliability and satisfaction as parameters, and optimizing evaluation results of the We-map through reinforcement learning.

The We-map intelligent recommendation specifically includes realizing intelligent recommendation and distribution of the We-map on the basis of We-map factors including content, styles and themes and under support of the user interaction behavior and preference models.

Optionally, the intelligent making device on a mobile terminal includes:
an implementation process of the intelligent making system for we-map.

The intelligent making device on a mobile terminal for the We-map includes a We-map natural interaction interface designer, a We-map mapping interface optimizer, a We-map data processor, a We-map memory and a We-map user manager.

The We-map natural interaction interface designer includes realizing design of a natural interaction interface, and specifically includes realizing interface design of gesture interaction, voice interaction and eye movement interaction.

The We-map mapping interface optimizer specifically realizes optimal layout for a mapping interface.

The We-map data processor specifically includes fusing different modal data generated by gesture interaction, voice interaction and eye movement interaction, predicting mapping intentions of users according to mapping behavior and preferences of the users, and selecting We-map content through a We-map template to realize self-adaptive expression of the We-map content.

The We-map memory includes establishing a database for storing the We-map, which includes but not limited to a geospatial database, a natural interaction database, a database after multi-modal interaction information fusion, a We-map vector database, a We-map user database and a We-map symbol database required for We-map making.

The We-map user manager specifically includes operations of managing all registered users, setting user roles, editing user information and adding administrators.

Optionally, the We-map mapping interface optimizer specifically includes:
establishing a visual attention partition model through a visual attention mechanism, and dividing a user interface into three ranges including an optimal visual field, an effective visual field and the maximum visual field;
carrying out initial combination and distribution of basic elements according to importance of basic elements by using a differential evolution algorithm and taking main window design, toolbar design and common function design as the basic elements; and
designing an optimization algorithm of the mapping interface through a particle swarm optimization algorithm to obtain optimal layout of the mapping interface.

As shown in the above technical solutions, compared with the prior art, the intelligent making system and device for a We-map is disclosed, which solves the intelligent making problem of the We-map based on a mobile terminal under a self-media environment, solves the problem that cartographers are required to have professional cartographic knowledge and participate in specialized mapping skill training, and compensates the deficiencies of a slow mapping speed and a long making cycle of the existing map making technology, thereby providing the society with a faster and intelligent map making technology, boosting the development of cartography, and satisfying the major strategic needs of the country.

### BRIEF DESCRIPTION OF THE DRAWINGS

In order to more clearly describe the technical solutions in the embodiments of the disclosure or in the prior art, a brief introduction to the accompanying drawings required for the description of the embodiments or the prior art will be provided below. Obviously, the accompanying drawings in the following description are merely embodiments of the disclosure. Those of ordinary skill in the art can also derive other accompanying drawings from the provided accompanying drawings without making inventive efforts.

FIG. 1 is schematic characteristic diagrams of an intelligent making system and device for a We-map provided by the disclosure.

FIG. 2 is a schematic diagram of functional modules of an intelligent making system for a We-map provided by the disclosure.

FIG. 3 is a schematic diagram of a working process of a We-map natural interaction making module provided by the disclosure.

FIG. 4 is a schematic diagram of a working process of a multi-modal interaction data fusion device provided by the disclosure.

FIG. 5 is a schematic diagram of functional modules of an intelligent making device on a mobile terminal provided by the disclosure.

FIG. 6A is a schematic diagram of mapping gesture recognition of a We-map gesture interaction interface provided by the disclosure.

FIG. 6B is a schematic diagram of a gesture mapping example of a We-map gesture interaction interface provided by the disclosure.

FIG. 7 is a schematic diagram of a working process of a We-map mapping interface optimizer provided by the disclosure.

FIG. 8 is a schematic diagram of a working principle of a We-map data processor provided by the disclosure.

### DETAILED DESCRIPTION OF THE EMBODIMENTS

The technical solutions in the embodiments of the disclosure will be clearly and completely described below with reference to the accompanying drawings in the embodiments of the disclosure. Obviously, the described embodiments are merely some embodiments rather than all embodiments of the disclosure. All the other embodiments obtained by those of ordinary skill in the art based on the embodiments in the disclosure without creative efforts shall fall within the scope of protection of the disclosure.

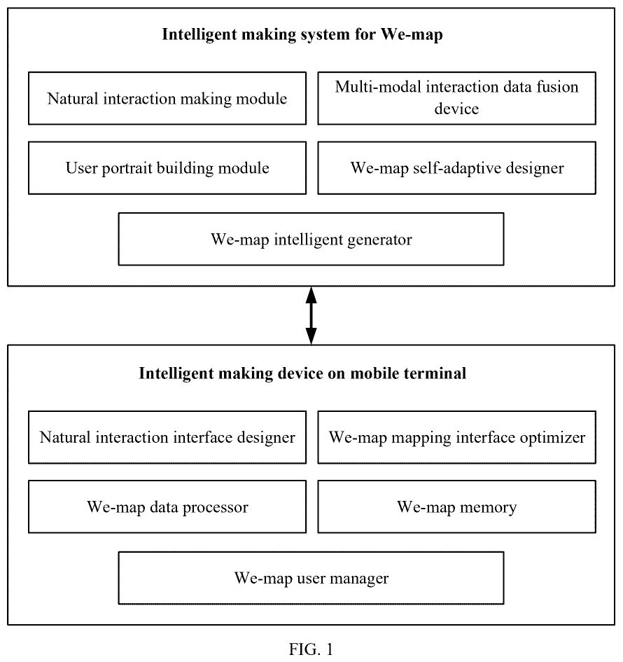

An intelligent making system and device for a We-map are disclosed in the embodiments of the disclosure, which include an intelligent making system for a We-map and an intelligent making device on a mobile terminal (as shown in FIG. 1).

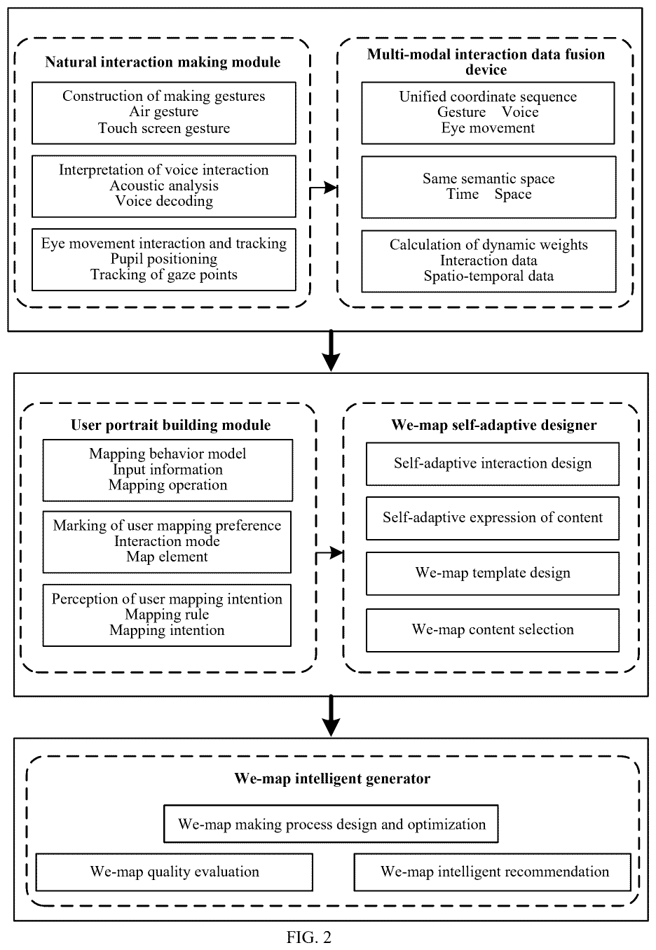

In order to further optimize the above technical solution, the intelligent making system for a We-map includes: a We-map natural interaction making module, a multi-modal interaction data fusion device, a user portrait building module, a We-map self-adaptive designer and a We-map intelligent generator (as shown in FIG. 2).

The We-map natural interaction making module obtains multi-modal interaction data for making the We-map through gesture interaction, voice interaction and eye movement interaction.

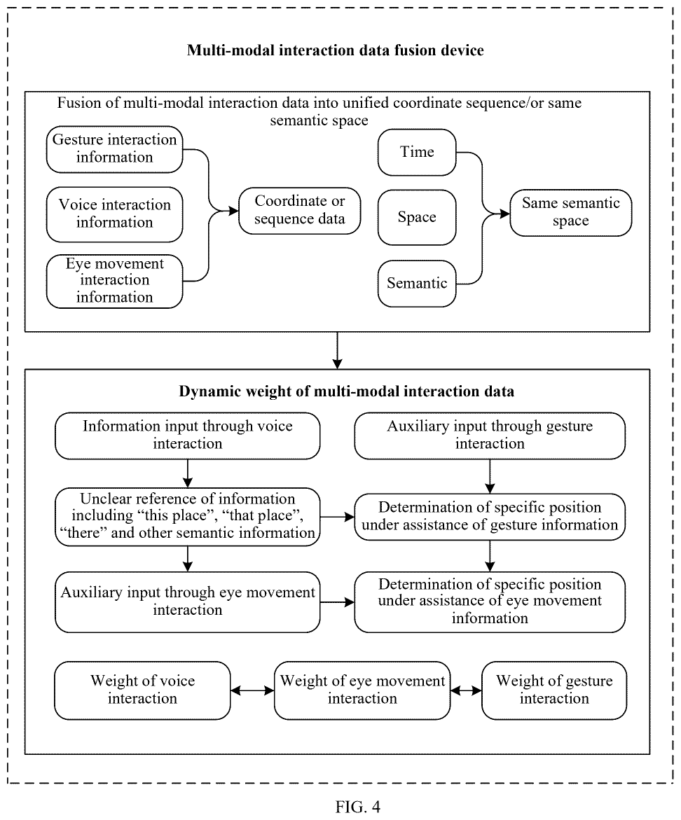

The multi-modal interaction data fusion device fuses the multi-modal interaction data into a unified coordinate sequence, fuses multi-modal interaction data of different time into the same semantic space, and calculates weights of the multi-modal interaction data, as shown in FIG. 4.

The user portrait building module divides users into different portrait groups by acquiring behavior data and behavior characteristics of the users.

The We-map self-adaptive designer can ensure content of the We-map matches We-map content in which the users are interested.

The We-map intelligent generator evaluates the quality of the We-map by designing and optimizing an intelligent making process for the We-map, and realizes personalized intelligent recommendation of the We-map.

In order to further optimize the above technical solution, the We-map natural interaction making module specifically includes construction of We-map making gestures, interpretation of voice interaction, and eye movement interaction and tracking.

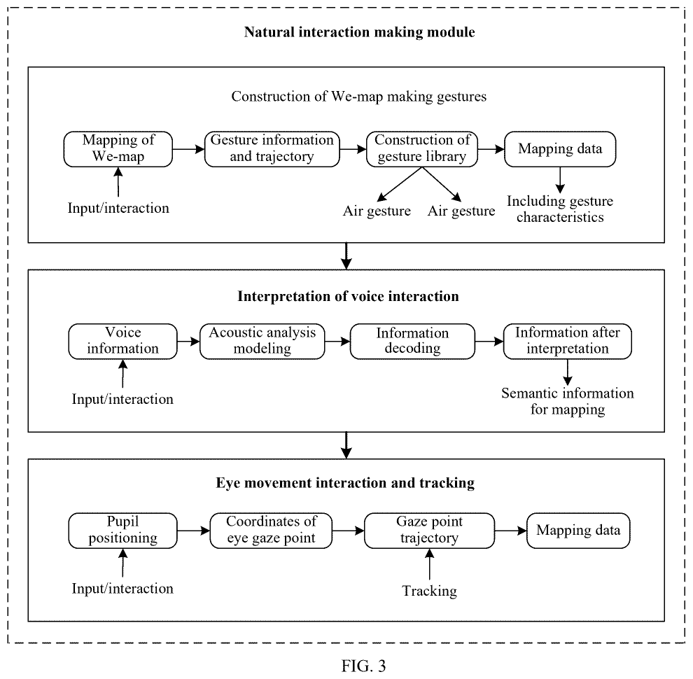

As shown in FIG. 3, the construction of We-map making gestures specifically includes extracting gesture characteristics of We-map making, capturing gesture information and trajectories of We-map making, and constructing an air gesture library and a touch screen gesture library to obtain input information of gesture interaction.

The interpretation of voice interaction specifically includes decoding input voice information through acoustic analysis modeling to obtain semantic information for mapping and complete interpretation of the voice interaction.

The eye movement interaction and tracking specifically includes positioning pupil positions to obtain coordinate data of eye gaze points, and obtaining input information of eye movement interaction by tracking eye movement gaze point trajectories.

In order to further optimize the above technical solution, for the multi-modal interaction data fusion device,
as shown in FIG. 4, calculation of the multi-modal interaction data mainly aims at the problem of unclear reference to position of input information in the voice interaction process, the specific position is determined through gesture information, and the dynamic weights of the multi-modal interaction data are calculated according to dynamic changes of the gesture information.

Unclear reference to location information specifically refers to the appearance of unclear reference information including “this place”, “here”, “that place”, “there” and “that side” in the process of user inputting information through voice interaction. At this time, it is necessary to assist in determining the specific position pointed by the user through gesture interaction or eye movement interaction. Since this process is not formed by a single interaction mode, it is necessary to calculate the weights of the data produced by different interaction modes to serve fast and convenient We-map making.

In order to further optimize the above technical solution, the user portrait building module specifically includes building of a mapping behavior model, marking of user mapping preferences and perception of user mapping intentions.

The building of a mapping behavior model specifically includes mining input information behavior and mapping operation characteristics of the users in the process of We-map making, thereby establishing the mapping behavior model.

The marking of user mapping preferences specifically includes marking interaction modes of the users in combination with the mapping behavior and the behavior model with operation characteristics of the users, and recording tendencies of the users to select map elements.

The perception of user mapping intentions specifically includes constructing rules for inferring mapping intentions of the users on the basis of contextual information of We-map making, thereby perceiving and predicting mapping purposes of the users.

In order to further optimize the above technical solution, the We-map self-adaptive designer specifically includes self-adaptive interaction design under user perceptions, self-adaptive expression of We-map content, design of We-map templates and selection of the We-map content.

In order to further optimize the above technical solution, for the We-map intelligent generator,
the We-map making process design and optimization refers to aiming at the characteristics of a low threshold, micro-content, personalization and a fast making speed of the We-map, establishing a common making process for the We-map, and optimizing the making process for the We-map according to user preferences.

The We-map evaluation further includes constructing a We-map evaluation model by taking evaluation factors including data quality, map functionality, aesthetics, explicability, reliability and satisfaction as parameters, and optimizing evaluation results of the We-map through reinforcement learning.

The We-map intelligent recommendation specifically includes realizing intelligent recommendation and distribution of the micro We-map on the basis of We-map factors including content, styles and themes and under support of the user interaction behavior and mapping preference models.

In order to further optimize the above technical solution, the intelligent making device on a mobile terminal includes:
an implementation process of the intelligent making system for we-map.

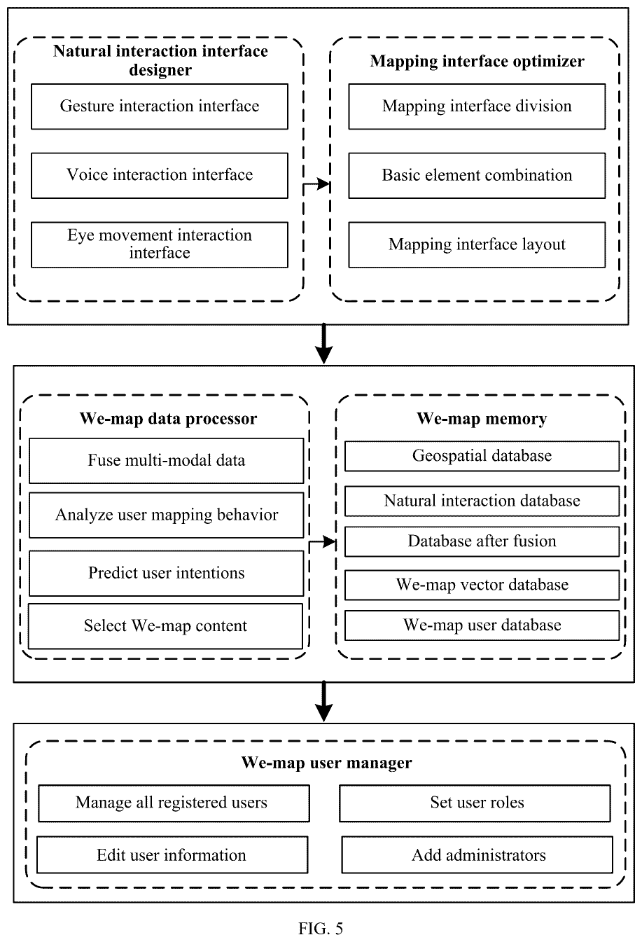

As shown in FIG. 5, the intelligent making device on a mobile terminal for the We-map is composed of a We-map natural interaction interface designer, a We-map mapping interface optimizer, a We-map data processor, a We-map memory and a We-map user manager.

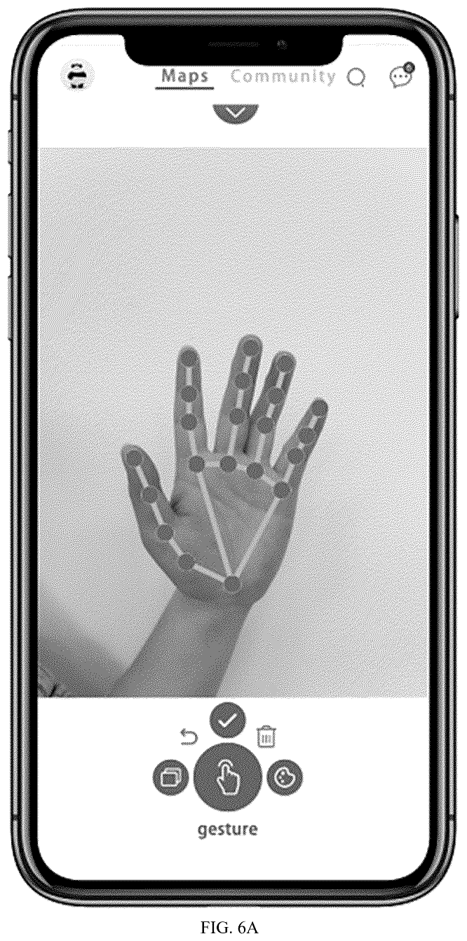

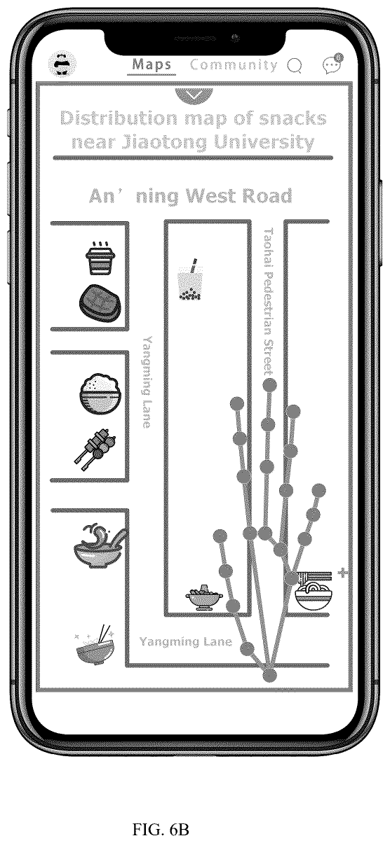

The We-map natural interaction interface designer includes realizing design of a natural interaction interface, and specifically includes realizing interface design of gesture interaction, voice interaction and eye movement interaction. As shown in FIG. 6A, taking the interface design of gesture interaction as an example, gestures are captured and recognized by a camera of the mobile terminal. As shown in FIG. 6B, it provides basic support for construction of gestures in the natural interaction making module in the intelligent making system for a We-map, thereby realizing the purpose of making the We-map by using the gestures.

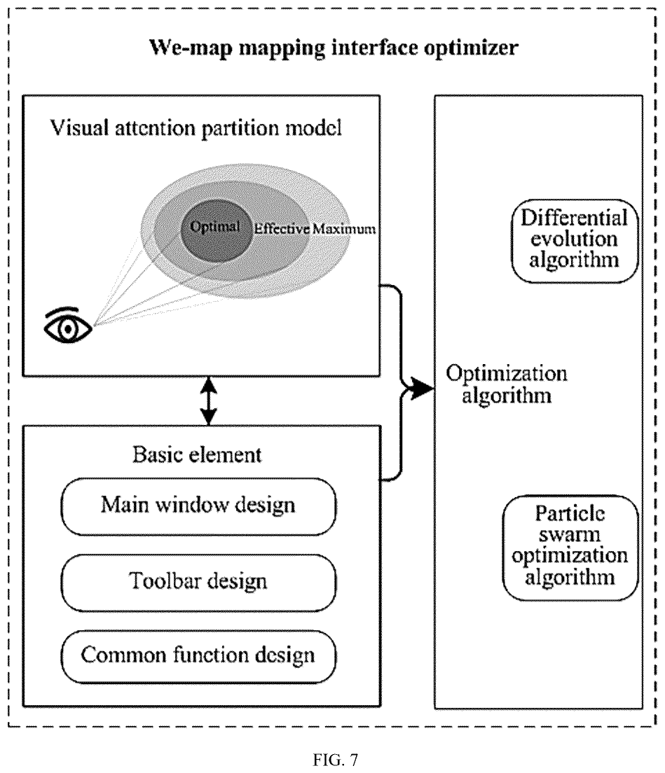

The We-map mapping interface optimizer specifically realizes optimal layout for a mapping interface, as shown in FIG. 7.

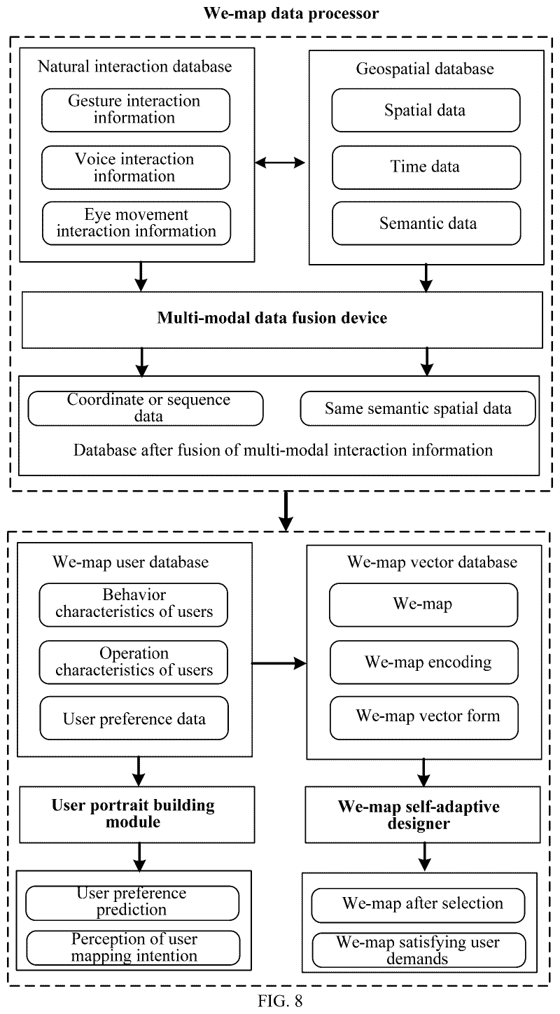

The We-map data processor specifically includes fusing different modal data generated by gesture interaction, voice interaction and eye movement interaction, predicting mapping intentions of users according to mapping behavior and preferences of the users, and selecting We-map content through a We-map template to realize self-adaptive expression of the We-map content, as shown in FIG. 8.

The We-map memory includes establishing a database for storing the We-map, which includes but not limited to a geospatial database, a natural interaction database, a database after multi-modal interaction information fusion, a We-map vector database and a We-map user database required for We-map making, and FIG. 8 also shows some databases in the We-map memory.

The We-map user manager specifically includes operations of managing all registered users, setting user roles, editing user information and adding administrators.

In order to further optimize the above technical solution, for the We-map mapping interface optimizer,

As shown in FIG. 7, a visual attention partition model is established through a visual attention mechanism, and a user interface is divided into three ranges including an optimal visual field, an effective visual field and the maximum visual field.

Initial combination and distribution of basic elements are carried out according to importance of basic elements by using a differential evolution algorithm and taking main window design, toolbar design and common function design as the basic elements.

An optimization algorithm of the mapping interface is designed through a particle swarm optimization algorithm to obtain optimal layout of the mapping interface.

The intelligent making system and device for a We-map provided by the disclosure has the following characteristics:
(1) overcoming the defects of high requirements on cartographers and a slow making speed during We-map making;
(2) solves the intelligent making problem of the We-map based on a mobile terminal under a self-media environment; and
(3) boosting the development of cartography, and providing the society with a faster and intelligent map making technology.

Various embodiments in this description are described in a progressive manner, differences between each embodiment and other embodiments are mainly described, and the same and similar portions among various embodiments are seen from each other for reference. Since a device disclosed in the embodiments corresponds to a method disclosed in the embodiments, its description is relatively simple, and relevant contents may be seen from partial description of the method.

The above description of the disclosed embodiments enables professionals skilled in the art to achieve or use the disclosure. Various modifications to these embodiments are readily apparent to professionals skilled in the art, and the general principles defined herein may be implemented in other embodiments without departing from the spirit or scope of the disclosure. Therefore, the disclosure is not limited to the embodiments shown herein but falls within the widest scope consistent with the principles and novel features disclosed herein.

What is claimed is:

1. An intelligent making system for a We-map, wherein
the intelligent map-making system for a We-map is used for achieving the technical objective that the We-map is capable of being made intelligently on a mobile terminal under a self-media environment, overcoming the defects of a high threshold, a long cycle, a slow mapping speed, lack of personalization and redundant content of an existing map making technology, and is composed of a We-map natural interaction making module, a multi-modal interaction data fusion device, a user portrait building module, a We-map self-adaptive designer and a We-map intelligent generator;
the We-map natural interaction making module comprises but not limited to gesture interaction, voice interaction and eye movement interaction, so as to solve the technical problem of a high threshold of map making;
the multi-modal interaction data fusion device comprises fusion of multi-modal natural interaction data and calculation of weights of the multi-modal interaction data, so as to solve the technical problems of a long cycle and a slow mapping speed of map making;
the user portrait building module comprises building of a mapping behavior model, marking of user mapping preferences and perception of user mapping intentions, and is used for overcoming the defects of ignoring user feelings, preferences and similar special needs in map making and expression processes;
the We-map self-adaptive designer has the functions of layout design of We-map elements, color matching and matching We-map styles in which users are interested in, so as to guarantee personalized characteristics to be retained in the We-map making process and content of the We-map to be capable of satisfying demands under specific circumstances; and
the We-map intelligent generator comprises We-map making process design and optimization, We-map evaluation and We-map intelligent recommendation, so as to achieve the technical objectives of easy making and instant provision of the We-map.

2. The intelligent map-making system for a We-map according to claim 1, wherein in the We-map natural interaction making module,
the gesture interaction refers to construction and recognition of We-map making gestures;
the voice interaction refers to interpretation of voice information input by the users;
the eye movement interaction refers to tracking of eye movement information in the mapping process by the users;
the construction of We-map making gestures comprises extracting gesture characteristics of We-map making, capturing gesture information and trajectories of We-map making, and constructing an air gesture library and a touch screen gesture library to obtain input information of the gesture interaction;
the interpretation of voice information input by the users specifically comprises decoding input voice information through acoustic analysis modeling to obtain semantic information for mapping and complete interpretation of voice interaction; and
the tracking of eye movement information in the mapping process by the users specifically comprises positioning pupil positions to obtain coordinate data of eye gaze points, and obtaining input information of eye movement interaction by tracking eye movement gaze point trajectories.

3. The intelligent map-making system for a We-map according to claim 1, wherein for the multi-modal interaction data fusion device,
the fusion of multi-modal natural interaction data comprises fusion of multi-modal interaction data of different time and fusion of multi-modal interaction data of different spaces;
the fusion of multi-modal interaction data of different time refers to fusing data at different time nodes into unified coordinate data;
the fusion of multi-modal interaction data of different spaces refers to fusing data generated by gesture interaction, data generated by voice interaction and data generated by eye movement interaction into the same mapping semantic space; and
the calculation of weights of the multi-modal interaction data refers to aiming at unclear reference of the input information in any natural interaction process, and making the input information in another natural interaction process supplement the mapping process by calculating the weights of the multi-modal natural interaction data.

4. The intelligent map-making system for a We-map according to claim 1, wherein in the user portrait building module,
the building of a mapping behavior model refers to mining map browsing behavior data and map making operation characteristics of the users, and dividing the users into different portrait groups;
the marking of user mapping preferences refers to analyzing interaction modes of the users, thereby constructing personalized preference models of the users; and
the perception of user mapping intentions refers to constructing rules for inferring mapping intentions of the users and predicting mapping behavior and purposes of the users.

5. The intelligent map-making system for a We-map according to claim 1, wherein the We-map self-adaptive designer further comprises self-adaptive interaction design under user perceptions, self-adaptive expression of We-map content, design of We-map templates and selection of the We-map content.

6. The intelligent map-making system for a We-map according to claim 1, for the We-map self-adaptive designer,
the self-adaptive interaction design under user perceptions refers to analyzing quantitative differences between different interaction modes and constructing a rule-driven model to improve an intelligent degree of We-map interaction;
the self-adaptive expression of We-map content comprises compensating deficiencies of cartographic users in cartographic knowledge storage by adjusting relationships among the users, devices, the data and the cartographic rules, thereby assisting the cartographic users in completing map making;
the design of We-map templates refers to summarizing, sorting and extracting various rules for map making, constructing a mapping rule base of the We-map templates, designing recommended rules and methods of the map templates, and providing diversified mapping solutions for cartographers; and
the selection of the We-map content comprises providing support for the intelligent selection of the We-map content by using interests and preferences of the users as parameters.

7. The intelligent map-making system for a We-map according to claim 1, wherein the We-map intelligent generator further comprises evaluating the quality of the We-map by designing and optimizing the intelligent making process for the We-map, and realizing personalized intelligent recommendation of the We-map;
the We-map making process design and optimization refer to aiming at the characteristics of a low threshold, micro-content, personalization and a fast making speed of the We-map, establishing a common making process for the We-map, and optimizing the making process for the We-map according to user preferences;
the We-map evaluation further comprises constructing a We-map evaluation model by taking evaluation factors comprising data quality, map functionality, aesthetics, explicability, reliability and satisfaction as parameters, and optimizing evaluation results of the We-map through reinforcement learning; and
the We-map intelligent recommendation specifically comprises realizing intelligent recommendation and distribution of the micro We-map on the basis of We-map factors comprising content, styles and themes and under support of a mapping behavior model and a mapping preference model.

8. An intelligent map-making device on a mobile terminal, comprising:
the intelligent making system for a We-map according to claim 1;
the intelligent making device on a mobile terminal for a We-map comprises a We-map natural interaction interface designer, a We-map mapping interface optimizer, a We-map data processor, a We-map memory and a We-map user manager, so as to fill the technical blank that an existing map making device is concentrated on a network terminal and a computer desktop terminal, and a map making device on a mobile terminal is lacked;
the We-map natural interaction interface designer comprises realizing design of a natural interaction interface, and specifically comprises realizing interface design of gesture interaction, voice interaction and eye movement interaction;
the We-map mapping interface optimizer specifically realizes optimal layout for a mapping interface;
the We-map data processor specifically comprises fusing different modal data generated by gesture interaction, voice interaction and eye movement interaction, predicting mapping intentions of users according to mapping behavior and preferences of the users, and selecting We-map content through a We-map template to realize self-adaptive expression of the We-map content;
the We-map memory comprises establishing a database for storing the We-map, which comprises but not limited to a geospatial database, a natural interaction database, a database after multi-modal interaction information fusion, a We-map vector database, a We-map user database and a We-map symbol database required for We-map making; and
the We-map user manager specifically comprises operations of managing all registered users, setting user roles, editing user information and adding administrators.

9. The intelligent map-making device on a mobile terminal according to claim 8, wherein the We-map mapping interface optimizer further comprises:
establishing a visual attention partition model through a visual attention mechanism, and dividing a user interface into three ranges comprising an optimal visual field, an effective visual field and the maximum visual field;
carrying out initial combination and distribution of basic elements according to importance of basic elements by using a differential evolution algorithm and taking main window design, toolbar design and common function design as the basic elements; and
designing an optimization algorithm of the mapping interface through a particle swarm optimization algorithm to obtain optimal layout of the mapping interface.
